(19) United States
(12) Patent Application Publication
(10) Pub. No.: US 2006/0156361 A1
(43) Pub. Date: Jul. 13, 2006

(54) Remote viewing system

(76) Inventors: Walter W. Wang, Cedar Grove, NJ (US); Shirley Wang, Cedar Grove, NJ (US); Pao Yu An, Morris Plains, NJ (US)

Correspondence Address: DUANE MORRIS LLP, PO BOX 5203, PRINCETON, NJ, 08543-5203, US

(21) Appl. No.: 11/328,647

(22) Filed: Jan. 10, 2006

Related U.S. Application Data
(60) Provisional application No. 60/643,304, filed on Jan. 12, 2005.

(51) Int. Cl. H04N 7/173; H04N 7/18; H04N 9/47

(52) U.S. Cl. 725/105; 348/143; 348/156

(57) ABSTRACT

A remote viewing system is disclosed for providing video and/or audio surveillance of an entry or doorway of a building. The system is provided within the panels of the entry or doorway door. A video camera is positioned within the panels to obtain video images of the entryway or doorway and to transmit them via Bluetooth wireless connection to a remote viewing station. The Wireless driver for the camera can be located in or adjacent to the door panel. Video and audio data can be transmitted from the driver to any of a variety of Bluetooth enabled electronic devices, including PCs, PDAs, cell phones, and the like.

### CROSS-REFERENCE TO RELATED APPLICATION

This is a non-provisional application of pending U.S. provisional patent application Ser. No. 60/643,304, filed Jan. 12, 2005, by Wang et al., titled “Remote Viewing System,” the entire contents of which is incorporated by reference herein.

### FIELD OF THE INVENTION

This invention relates to a remote viewing system, and more particularly to a viewing system that can be installed within the structure of a door for observation of the surrounding area from a remote location.

### BACKGROUND OF THE INVENTION

A wide variety of security systems exist to provide audio and video surveillance of entrance areas of buildings. Such systems can consist of wall mounted video cameras and intercom systems that allow a person inside the building to monitor the exterior of the building and to admit or deny entry based on the information obtained from the audio or video data. For example, an external security door in a building can have a wall mounted video camera for providing real time and/or recorded video feeds to one or more monitors located inside the building, such as at a security station. An intercom can also be provided to allow a person seeking entry to the building to speak live to an individual manning the security station. Such audio and video equipment typically is hardwired through the building walls, and is run to the security station where an array of controlling electronics can be located.

Such systems, while effective, suffer from various practical deficiencies in that they can be expensive to install and maintain. Additionally, wall mounted video cameras may suffer from certain aesthetic liabilities, in that they can detract from the overall appearance of the entryway, such as where the building is a home or office. Additionally, where the dwelling is an apartment, it may not be possible or practical to install such equipment in the hallway outside the individual user's door. In short, present entrance surveillance equipment can be impractical for many users who otherwise would like to take advantage of the added personal security they afford.

Accordingly, there is a need for a security viewing system for monitoring a door or other entryway, in which the system can be installed and used without a substantial affect on the aesthetics of the entryway. There is also a need for a viewing system that can be implemented in a manner that will be largely unnoticeable from the exterior of the door or entryway. Further, there is a need for a viewing system that can be provided as an integral part of the door, and is also contained within the door structure so as to give the system the appearance of a normal door, but which can transmit video and/or audio data remotely to a monitor within the building/dwelling, or even to a location outside of the building/dwelling.

### SUMMARY OF THE INVENTION

A system is disclosed for providing video and/or audio data to a monitoring station. Preferably the system comprises a video camera, with an optional microphone, both of which are disposed within the panels of a standard entryway door. Additionally the system can comprise appropriate electronics for processing, storing, and transmitting the video and/or audio data to a remote location. The video camera and associated wiring can be located within the door itself, and the processing electronics can be located adjacent to the door either on or in the wall structure. Alternatively, the electronics can also be located within the door panels so as to be hidden from the outside of the door. Data transmission can be via hard wiring that is run directly from the door to the monitoring station. Alternatively, wireless technology such as Bluetooth technology can be used to remotely transmit the data to the monitoring station. A monitoring or other receiving station can be provided within the dwelling or building at a location suitable for receiving the remote signal from the in-door system. The monitoring station can comprise a monitor, such as a laptop computer with built-in speaker. The monitoring station also can be configured to route the received information over a network to one or more additional receiving stations. In one embodiment, the network is the Internet, and at least one of the additional receiving stations is a user computer located outside of the building or dwelling, thus allowing a user to monitor his or her front door while they are a the office.

Thus, a security system is disclosed for providing video data to a remote location. The system can comprise a door having front and back panels, and a camera disposed between the front and back panels of the door. The camera can be positioned to obtain video data from a location adjacent to the door. Processing circuitry can be associated with the camera for processing video data from the camera and transmitting the processed video data to a remote viewing location. The processing circuitry can be located on or in the adjacent wall structure, or can be disposed between the front and back panels of the door. A video monitor can be located at the remote viewing location for receiving the processed video data and for displaying the video data obtained from the camera. In one embodiment, the processed video data can be transmitted to the video monitor using a wireless module, such as a Bluetooth module.

The system can further comprising a microphone disposed within the front and back panels of the door and connected to the processing circuitry. A power supply can be provided, and can be associated with the camera and processing circuitry. In one embodiment, the power supply is a battery and is disposed within the front and back panels of the door. The system may further comprising a memory element associated with the processor, the memory element being capable of storing the processed video data. The camera can have a sleep mode in which the camera does not operate to provide video data to the processing circuitry, and an operating mode in which the camera is operable to transmit video data to the processing circuitry. The camera can be configurable to the operating mode upon receipt of a triggering signal. The triggering signal can be provided by a motion detector disposed adjacent to the camera.

### BRIEF DESCRIPTION OF THE DRAWINGS

The accompanying drawings illustrate preferred embodiments of the invention so far devised for the practical application of the principles thereof, and in which:

FIG. 1 is a front view of an exemplary door unit and viewing station of the remote viewing system of the present invention;

FIG. 1a is a partial front view of an exemplary door unit showing the position of an exemplary camera lens;

FIG. 2 is a side section view of the door of FIG. 1 showing an exemplary camera and associated processing board disposed between the door panels;

FIG. 2a is a partial perspective view of the door of FIG. 1 showing the venting holes disposed on the bottom of the door;

FIG. 3 is a schematic of the processing board of FIG. 2, showing the main components of the board and the connections to a wireless driver;

FIG. 3a is a perspective view of the board and associated components of FIG. 3;

FIG. 4 is a perspective view of an embodiment of the remote viewing station comprising a laptop computer for use in receiving video and audio data from the wireless transmitter via a wireless USB connector.

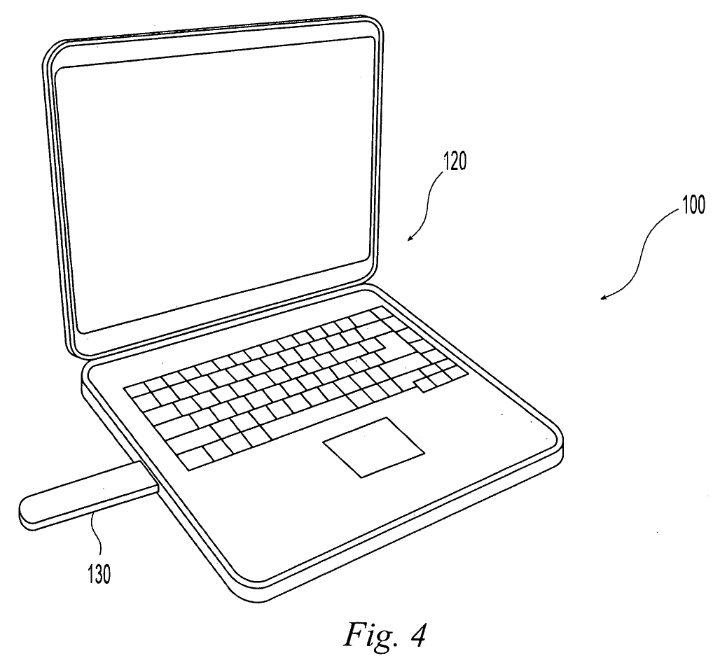

### DETAILED DESCRIPTION OF THE INVENTION

This invention is directed to a system for providing remote monitoring of a doorway or entryway, in which a substantial portion of the system can be installed within the panels of the door itself, thus rendering it unnoticeable from the exterior (as well as the interior) of the door. The system can be installed in any of a variety of standard door sizes, thus allowing a user to install the system with a minimum of disruption to the surroundings.

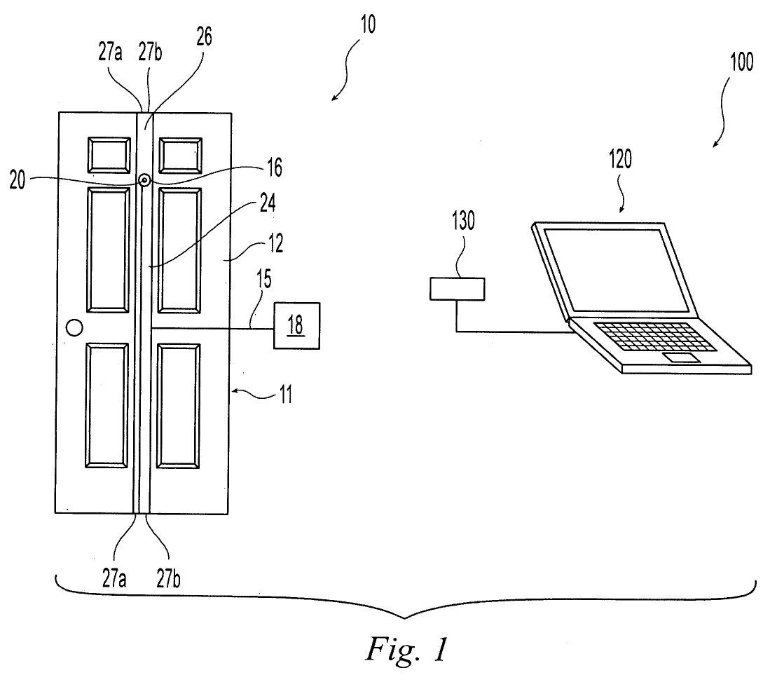

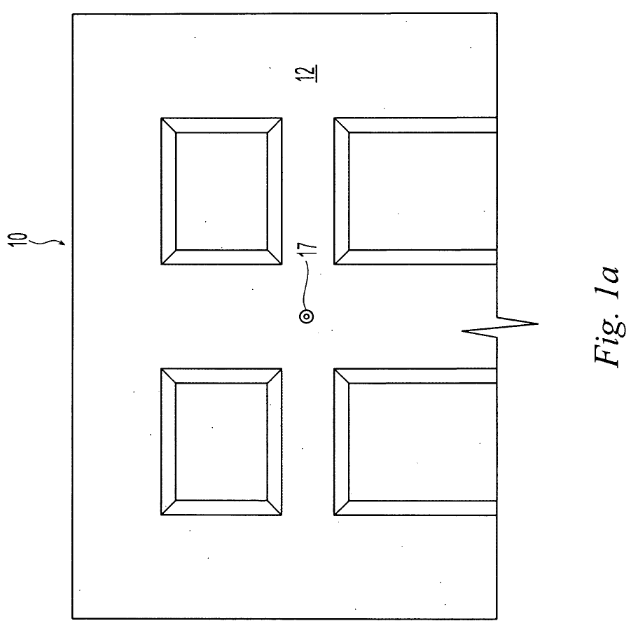

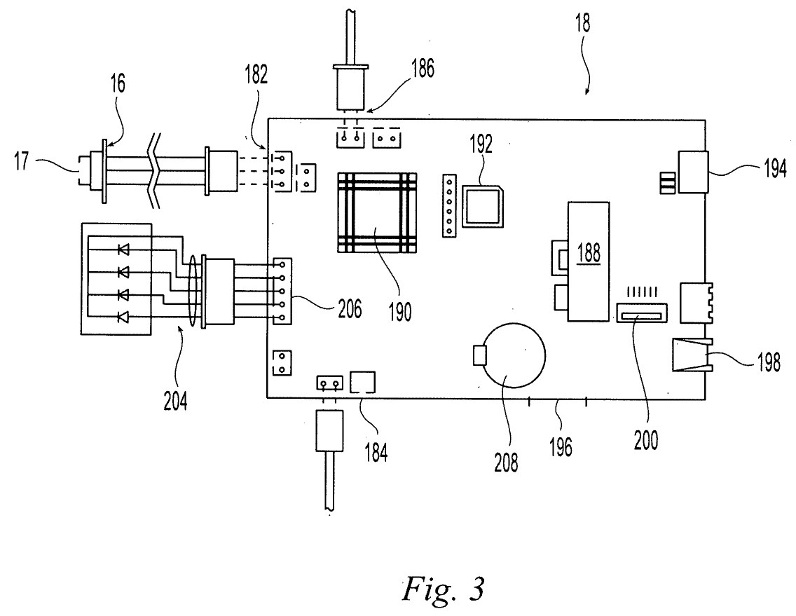

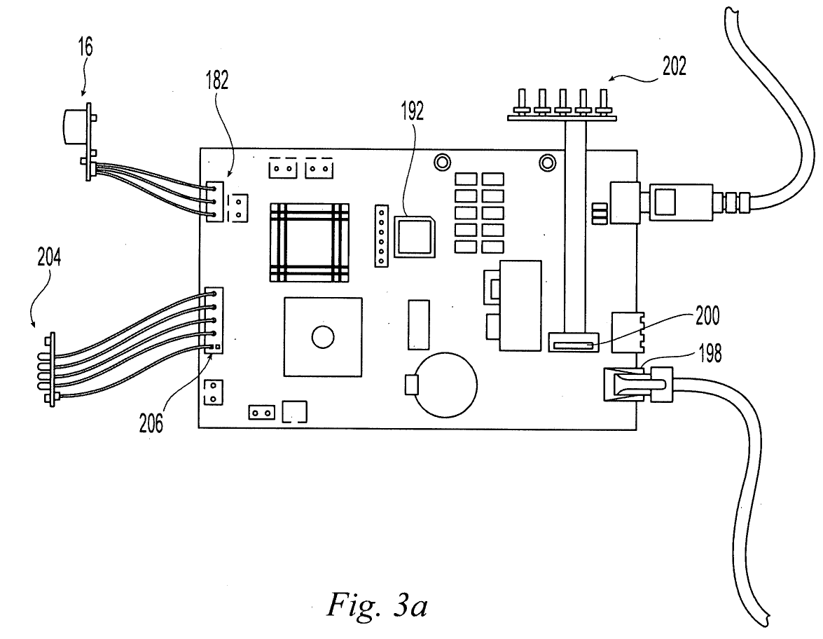

Referring to FIG. 1, an exemplary door unit 10 and remote viewing station 100 are shown. The door unit 10 can comprise first and second door panels 12, 14, and a video camera 16 disposed therebetween. The video camera 16 can be wireless or Bluetooth compatible, and can be controlled using a wireless driver 18 (FIG. 3), such as a Bluetooth driver located adjacent to the door 10. The wireless driver 18 can power the camera 16, and can process the video data provided from the camera 16 and transmit that processed data to the remote viewing station 100 for review by a user. An example of an appropriate driver would be that contained in the VDH-2201 “Video Black Box,” manufactured by ViVoDa Communications, Inc. 1072 S. De Anza Blvd., Ste. A107-301 San Jose, Calif. 95129. The remote viewing station 100 can comprise a laptop computer 120 equipped with a wireless PC card or a wireless USB adapter 130. The camera 16 can be any of a variety of appropriate miniature embeddable commercial video camera designs, such as bullet cameras or the like.

A microphone can also be provided as part of the door assembly, to allow the user to monitor audio communications and/or to communicate with a person standing in the entryway. The microphone could connect to a port 184 on the wireless driver 18 (see FIGS. 3 and 3a), and would be controlled using the driver 18 in the same manner as the camera 16. For two-way communications, a speaker could likewise be mounted in or near the door.

As noted the wireless driver 18 can be located adjacent to the door 10. Thus, the driver can be located on or in an adjacent wall panel. Alternatively, the driver 18 could be located on the rear panel 14 of the door 10. Since the driver 18 both powers and controls the camera 16, a connection between the two is provided by driver wires 24 that run between the door panels 12, 14.

As can be seen from FIG. 1, the door 10 itself has the outward appearance of a standard entryway door, and the camera 16 is positioned within the door 10 at about the same location as a standard viewing window (“peep hole”). A custom port can be drilled in the door to fit the specific lens 17 size of the camera used. Thus, the system can be arranged so that a person approaching the door will not be aware of the camera or the associated electronics.

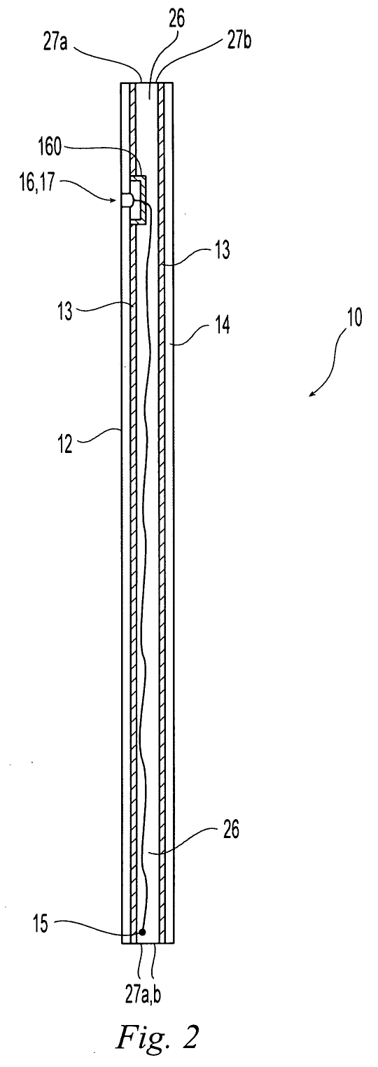

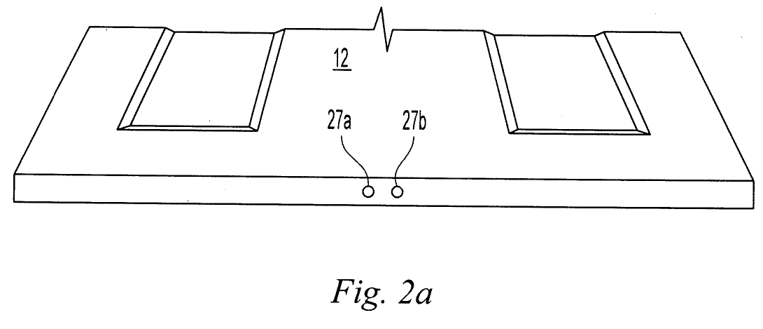

Referring to FIG. 2, the camera 16 can be directly mounted to the door 10, or it can be located within a standard junction box 160 which itself is embedded within the door 10. A vent 26 can be provided within the door structure to allow heat generated by the camera 16 during operation to be adequately dissipated. Proper heat dissipation is important to ensure long term reliability of the device. The vent 26 can comprise a vertical channel cut through the foam core 13 of the door. In the illustrated embodiment, the channel runs the entire vertical height of the door, and connects to a pair of vent holes 27a, b located at the top and bottom ends of the door. The venting channel can run the entire thickness of the door panel, and can also be about 1½″ wide.

The door 10 has a foam core 13 which is sandwiched between the door panels 12, 14. Suitable cavities are easily formed within the foam core 13 to accommodate the components, as shown. Thus, the camera 16 and its junction box 160, along with the driver wires 24, can all be embedded within the foam. At least a portion of the camera should be exposed to the vent 26 to allow shedding of heat.

One or more small openings can be provided in the hinge-side door stile 11 (see FIG. 1), through which the driver wiring 24 can protrude for connecting to the wireless driver 18, which as noted can be mounted adjacent to the door 10. Thus, the wiring 24 can pass from the door 10 directly through a corresponding opening in the associated doorjamb to connect to the wireless driver 18 located on, or embedded within, the adjacent wall. FIG. 1 shows the wiring 24 exiting through a port 15 in hinge-side stile 11 near the center of the door 10.

Referring to FIG. 3, an exemplary schematic of the wireless driver 18 is shown. The driver 18 has a camera connection port 182 for receiving video data from the camera 16, an audio port 184 for receiving audio input from an optional microphone (not shown). A hard wire video output port 186 is also shown for optional hard wired transmission of video data to a monitor. A wireless module 188 is provided for remote transmission of the collected video and/or audio data to the remote viewing station 100. Microprocessor 190 and memory 192 are also provided. The memory can be standard RAM, or can be flash-type memory for storing instructions for the processor or for buffering audio and/or video data prior to transmission to the remote viewing station. An optional slot 196 can also be provided for addition of a separate memory card (not shown) for on-board storage of audio and video data.

A power supply port 194 for connection to an external power supply is provided. A backup battery power source 208 may also be provided on the driver 18 to prevent loss of data for cases in which external power is lost.

Additionally, a serial port 198 can be provided for connecting the driver 18 to any of a variety of data acquisition devices, such as an external data logger (for long-term on-board storage of audio or video), or the like. Alternatively, a data modem can be connected via this port for transmitting audio or video data directly to a user computer or network.

Although it is intended that the camera 16 and microphone will be controlled using the Wireless driver 18 via the remote viewing station 100, a port 200 can be provided for directly connecting a manual keypad 202 to the board for controlling component functions directly. Additionally, an operational indicator 204 can be connected to the driver 18 for providing constant indication of the status of any of the attached components. In the illustrated embodiment, the indicator 204 comprises a series of four LEDs. In one embodiment, a green indicator light simply would signal that the device is operational, while a red light would indicate malfunction of one or more components. The indicator 204 could be mounted on the rear panel 14 of the door to provide a constant visual indication of the status of the device. In one embodiment, the indicator could provide a specific indication when the camera 16 or microphone are recording.

FIG. 5 shows an exemplary remote viewing station 100 comprising a laptop computer 120 having a wireless USB connector 130 for receiving the audio and/or video data transmitted by the wireless module 188. A wireless-enabled computer 100 (outfitted at the factory or retrofitted with a wireless PC card) could also be used, thus eliminating the need for the wireless USB connector 130. The audio and video data can be transmitted to a user having a wireless-enabled PDA (personal digital assistant, such as a Palm Pilot), or a cellular telephone.

The computer 120 the remote viewing station 100 will have appropriate software loaded thereon for decompressing the transmitted audio and video and for converting it into a form suitable for viewing, and which further can be made available for viewing over the Internet or other network.

Thus, once the audio and video data has been transmitted to the remote viewing station 100 and converted, the information can be further provided via the internet, personal network, or the like, to any desired remote user having access to the Internet. For example, when the computer at the remote viewing station 100 receives audio or video data from the driver 18, an alerting e-mail (or alternatively a voice mail or text message) could be sent from the computer 120 to a user situated in a different geographic location. The computer 120 could then make the audio/video available through a connection to a predefined Internet address. Based on the alert, the user could then receive the audio/video information in real time directly on his or her Internet connected electronic device. Alternatively the user could connect remotely to their personal network to receive the audio/video information from the computer 120. Thus, the system could be used to allow a user to monitor the entryway of their home, apartment, business, etc. while at work, on a business trip, or on vacation, anywhere in the world in which Internet access is available.

The system can be configured to operate continuously to collect video and/or audio data from the camera 16 and microphone. Thus, in one embodiment, the processed audio and video data is continuously transmitted to the remote viewing station and is displayed to a user, and/or is recorded for later review as necessary. Alternatively, the processed audio and video data may be temporarily stored in the onboard memory card and batch-transmitted periodically.

Additionally, the system can be configured to have an operating mode and a sleep mode. The system can be set up so that the normal system configuration is in sleep mode, which will reduce the power required to operate the system, and will eliminate the recording of a large amount of low-value audio and video data. The system can be “woken up” (i.e. switched from sleep mode to operating mode) by a triggering event, such as a person or object approaching the door. Thus a motion detector can be provided as a trigger, as can an audio receiver which is configured to trigger the device when it encounters sound above a certain decibel threshold.

As an alternative to having only the camera 16 and associated driver wiring 24 located within the door 10, the wireless driver 18 also could be located within the door, thus providing an entirely enclosed door without the need for external communications wiring. A power supply wire still may be needed for powering the device, and it is expected that a variety of appropriate powering arrangements can be provided. For example, a simple power supply wire could be provided having sufficient play to allow opening and closing of the door without kinking the wire and without interfering with clearances between the stile 11 and the door jamb. Alternatively, the power wiring could be integrated into one or more of the hinges. Alternatives to hard wiring are the use of solar power (for doors exposed to the outside). Additionally, the temperature differential between the front and rear door panels could be used as a further alternative source of power. It is also contemplated that inductive powering (e.g. using the normal opening and closing movement of the door) could be used to power the device.

It is noted that the remote viewing system will have applicability to a wide range of applications, and is not limited to placement of a camera into an entryway door. Thus, a remote viewing video camera utilizing the described Bluetooth or other wireless technology can be placed in window frames, walls, patio doors, garage doors, security doors, and the like. Additionally, the device could be used in a variety of automobile applications, and the video camera could be installed in automobile doors, hoods, front or rear bumpers, etc. Thus, the device can be implemented in nearly any application in which wireless remote viewing is desired.

The present invention is also applicable to a system that allows a user to remotely unlock the door to allow entry to a selected person. Thus, when the system is triggered to transmit audio or video data (e.g. when a person approaches the door), a signal can be sent via the computer 120 to prompt a remote user (either via the Internet using e-mail or by sending a text or voice mail message to the user's cell phone) informing them of such. The user can then remotely access the computer 120 using the Internet to view the audio and/or video data to determine the identity of the individual. If the user wishes to grant access to the individual, the user can send an instruction to the computer 120, again via the Internet, to unlock the door.

The computer 120 could then send a signal to a controllable locking mechanism located in the door or the doorjamb that would unlock the door. This signal could be sent either via a hard wire connection or it could be a digital wireless signal, such as a Wi-Fi or Bluetooth wireless signal. The controllable locking mechanism could be an electrically fired solenoid connected to a deadbolt or other latching element. The solenoid could be powered by a battery and could also have a sleep mode configuration that would enable the solenoid to use minimum power. When the unlock signal is sent from the computer 120, the solenoid would “wake up” and operate to unlock the door. In one embodiment, the battery could be rechargeable, or it could be powered using any of the powering arrangements disclosed previously in relation to the driver 18 and camera.

Further, any of a variety of triggering mechanisms can be used for triggering the computer 120 to send the previously described prompt to a remote user. For example, a motion detector or thermal detector could be used to detect when an individual approaches the door. Likewise, a doorbell press could serve as the detector, as could a weight detector positioned in or beneath a door mat or door step.

Accordingly, it should be understood that the embodiments disclosed herein are merely illustrative of the principles of the invention. Various other modifications may be made by those skilled in the art which will embody the principles of the invention and fall within the spirit and the scope thereof.

What is claimed is:

1. A security system for providing video data to a remote location, the system comprising:
a door having front and back panels;
a camera disposed between the front and back panels of the door, the camera positioned to obtain video data from a location adjacent to the door;
processing circuitry associated with the camera for processing video data from the camera and transmitting the processed video data to a remote viewing location; the processing circuitry being disposed between the front and back panels of the door;
a video monitor located at the remote viewing location for receiving the processed video data and displaying the video data obtained from the camera, the processed video data being transmitted to the video monitor using a wireless module; and
a computer associated with the video monitor, the computer being configured to make the video data available to a user via a predefined ISP address on the Internet to allow viewing of the video data by a user having access to the predefined ISP address.

2. The system of claim 1, further comprising a microphone disposed within the front and back panels of the door and connected to the processing circuitry.

3. The system of claim 1, further comprising a power supply associated with the camera and processing circuitry, wherein the power supply is a battery and is disposed within the front and back panels of the door.

4. The system of claim 1, further comprising a memory element associated with the processing circuitry, the memory element being capable of storing the processed video data.

5. The system of claim 1, wherein the camera further has a sleep mode in which the camera is not operable to provide video data to the processing circuitry, and an operating mode in which the camera is operable to transmit video data to the processing circuitry, the camera being configurable to the operating mode upon receipt of a triggering signal.

6. The system of claim 5, wherein the triggering signal is provided by a motion detector disposed adjacent to the camera.

7. The system of claim 1, wherein the wireless module is a Bluetooth module.

8. The system of claim 1, wherein the wireless module is a Wi-Fi module.

9. A security system for providing video data to a remote location, the system comprising:
a door having front and back panels;
a camera disposed between the front and back panels of the door, the camera positioned to obtain video data from a location adjacent to the door;
processing circuitry associated with the camera for processing video data from the camera and transmitting the processed video data to a remote viewing location; at least a portion of the processing circuitry being disposed between the front and back panels of the door;
a wireless driver associated with the processing circuitry, said wireless driver having a wireless module for transmitting the processed video data from said processing circuitry; and
a video monitor located at the remote viewing location for receiving and displaying the processed video data received from the wireless module;
wherein at least a portion of the wireless driver is located between the front and back panels of the door.

10. The system of claim 9, further comprising a microphone disposed within the front and back panels of the door and connected to the processing circuitry.

11. The system of claim 9, further comprising a power supply associated with the camera and processing circuitry, wherein the power supply is a battery and is disposed within the front and back panels of the door.

12. The system of claim 9, further comprising a memory element associated with the processing circuitry, the memory element being capable of storing the processed video data.

13. The system of claim 9, wherein the camera further has a sleep mode in which the camera is not operable to provide video data to the processing circuitry, and an operating mode in which the camera is operable to transmit video data to the processing circuitry, the camera being configurable to the operating mode upon receipt of a triggering signal.

14. The system of claim 13, wherein the triggering signal is provided by a motion detector disposed adjacent to the camera.

15. The system of claim 9, further comprising a computer associated with the video monitor, the computer being configured to make the video data available to a user via a predefined ISP address on the Internet to allow viewing of the video data by a user having access to the predefined ISP address.

16. The system of claim 9, wherein the wireless module is a Bluetooth module.

17. The system of claim 9, wherein the wireless module is a Wi-Fi module.

18. A security system for providing video data to a remote location, the system comprising:
a door having front and back panels and a locking mechanism for locking the door in a door jamb;
a camera disposed between the front and back panels of the door, the camera positioned to obtain video data from a location adjacent to the door;
processing circuitry associated with the camera for processing video data from the camera; the processing circuitry being disposed between the front and back panels of the door;
a wireless driver associated with said processing circuitry, said wireless driver configured comprising a wireless module for transmitting the processed video data to a remote viewing location; and
a video monitor located at the remote viewing location for receiving and displaying the processed video from the wireless module;
wherein the wireless driver is located in a structure adjacent said door.

19. The security system of claim 18, further comprising a port for connecting the wireless driver to a data logger or modem.

20. The security system of claim 19, wherein the wireless driver is connected to the door via at least one wire that is received within an opening in a hinge-side stile of said door.
